(19) United States
(12) Patent Application Publication
(10) Pub. No.: US 2026/0129432 A1
(43) Pub. Date: May 7, 2026

(54) TRANSMITTING SECRET KEY AND/OR ARTIFICIAL NOISE BUFFER STATUS REPORTS

(71) Applicant: QUALCOMM Incorporated, San Diego, CA (US)

(72) Inventors: Ahmed ELSHAFIE, San Diego, CA (US); Alexandros MANOLAKOS, Athens (GR); Hung Dinh LY, San Diego, CA (US); Wanshi CHEN, San Diego, CA (US)

(21) Appl. No.: 19/118,181

(22) PCT Filed: Oct. 24, 2023
(86) PCT No.: PCT/US2023/077661

§ 371 Date: Apr. 3, 2025

(30) Foreign Application Priority Data
Nov. 22, 2022 (GR) 20220100959

(51) Int. Cl. H04W 12/033; H04W 28/02

(52) U.S. Cl. CPC H04W 12/033; H04W 28/0278

(57) ABSTRACT

Various aspects of the present disclosure generally relate to wireless communication. In some aspects, a first user equipment (UE) may transmit, to a network node or a second UE, a secret key (SK)/artificial noise (AN) (SK/AN) buffer status report (BSR) that includes information associated with one or more of an SK or an AN. The first UE may transmit, to the network node or the second UE and based at least in part on the SK/AN BSR, a data BSR that indicates data that is available for transmission. The first UE may transmit, to the network node or the second UE, the data that is available based at least in part on the data BSR, wherein the data is secured based at least in part on one or more of the SK or the AN indicated by the SK/AN BSR. Numerous other aspects are described. WO

### CROSS-REFERENCE TO RELATED APPLICATION

This Patent Application claims priority to Greek Nonprovisional Patent Application No. 20220100959, filed on Nov. 22, 2022, entitled “TRANSMITTING SECRET KEY AND/OR ARTIFICIAL NOISE BUFFER STATUS REPORTS,” which is hereby expressly incorporated by reference herein.

### FIELD OF THE DISCLOSURE

Aspects of the present disclosure generally relate to wireless communication and to techniques and apparatuses for transmitting secret key and/or artificial noise (SK/AN) buffer status reports (BSRs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a first user equipment (UE) includes a memory and one or more processors, coupled to the memory, configured to: transmit, to a network node or a second UE, a secret key (SK)/artificial noise (AN) (SK/AN) buffer status report (BSR) that includes information associated with one or more of an SK or an AN; transmit, to the network node or the second UE and based at least in part on the SK/AN BSR, a data BSR that indicates data that is available for transmission; and transmit, to the network node or the second UE, the data that is available based at least in part on the data BSR, wherein the data is secured based at least in part on one or more of the SK or the AN indicated by the SK/AN BSR.

In some implementations, an apparatus for wireless communication at a network node includes a memory and one or more processors, coupled to the memory, configured to: receive, from a UE, an SK/AN BSR that includes information associated with one or more of an SK or an AN; receive, from the UE and based at least in part on the SK/AN BSR, a data BSR that indicates data that is available for transmission; and receive, from the UE, the data that is available based at least in part on the data BSR, wherein the data is secured based at least in part on one or more of the SK or the AN indicated by the SK/AN BSR.

In some implementations, a method of wireless communication performed by an apparatus of a first UE includes transmitting, to a network node or a second UE, an SK/AN BSR that includes information associated with one or more of an SK or an AN; transmitting, to the network node or the second UE and based at least in part on the SK/AN BSR, a data BSR that indicates data that is available for transmission; and transmitting, to the network node or the second UE, the data that is available based at least in part on the data BSR, wherein the data is secured based at least in part on one or more of the SK or the AN indicated by the SK/AN BSR.

In some implementations, a method of wireless communication performed by an apparatus of a network node includes receiving, from a UE, an SK/AN BSR that includes information associated with one or more of an SK or an AN; receiving, from the UE and based at least in part on the SK/AN BSR, a data BSR that indicates data that is available for transmission; and receiving, from the UE, the data that is available based at least in part on the data BSR, wherein the data is secured based at least in part on one or more of the SK or the AN indicated by the SK/AN BSR.

In some implementations, a non-transitory computer-readable medium storing a set of instructions for wireless communication includes one or more instructions that, when executed by one or more processors of a first UE, cause the first UE to: transmit, to a network node or a second UE, an SK/AN BSR that includes information associated with one or more of an SK or an AN; transmit, to the network node or the second UE and based at least in part on the SK/AN BSR, a data BSR that indicates data that is available for transmission; and transmit, to the network node or the second UE, the data that is available based at least in part on the data BSR, wherein the data is secured based at least in part on one or more of the SK or the AN indicated by the SK/AN BSR.

In some implementations, a non-transitory computer-readable medium storing a set of instructions for wireless communication includes one or more instructions that, when executed by one or more processors of a network node, cause the network node to: receive, from a UE, an SK/AN BSR that includes information associated with one or more of an SK or an AN; receive, from the UE and based at least in part on the SK/AN BSR, a data BSR that indicates data that is available for transmission; and receive, from the UE, the data that is available based at least in part on the data BSR, wherein the data is secured based at least in part on one or more of the SK or the AN indicated by the SK/AN BSR.

In some implementations, a first apparatus for wireless communication includes means for transmitting, to a network node or a second apparatus, an SK/AN BSR that includes information associated with one or more of an SK or an AN; means for transmitting, to the network node or the second apparatus and based at least in part on the SK/AN BSR, a data BSR that indicates data that is available for transmission; and means for transmitting, to the network node or the second apparatus, the data that is available based at least in part on the data BSR, wherein the data is secured based at least in part on one or more of the SK or the AN indicated by the SK/AN BSR.

In some implementations, an apparatus for wireless communication includes means for receiving, from a UE, an SK/AN BSR that includes information associated with one or more of an SK or an AN; means for receiving, from the UE and based at least in part on the SK/AN BSR, a data BSR that indicates data that is available for transmission; and means for receiving, from the UE, the data that is available based at least in part on the data BSR, wherein the data is secured based at least in part on one or more of the SK or the AN indicated by the SK/AN BSR.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of secure communications, in accordance with the present disclosure.

FIG. 5 is a diagram illustrating an example of a potential eavesdropper UE, in accordance with the present disclosure.

FIG. 6 is a diagram illustrating an example of buffer status reports (BSRs), in accordance with the present disclosure.

FIGS. 7-10 are diagrams illustrating examples associated with transmitting secret key and/or artificial noise (SK/AN) BSRs, in accordance with the present disclosure.

FIGS. 11-12 are diagrams illustrating example processes associated with transmitting SK/AN BSRs, in accordance with the present disclosure.

FIGS. 13-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

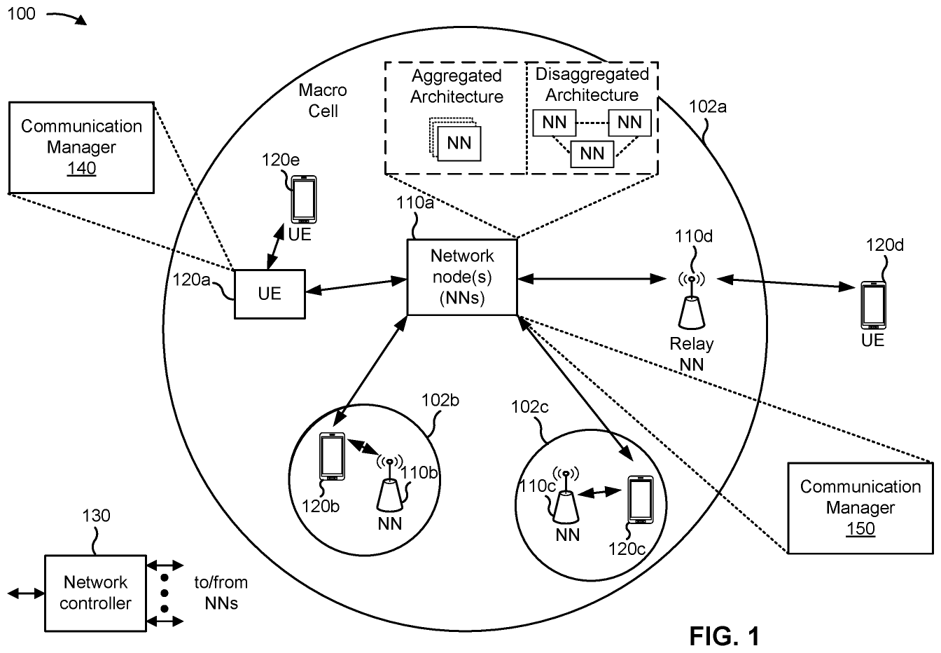

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR 1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120a) may include a communication manager 140. As described in more detail elsewhere herein, the communication manager 140 may transmit, to a network node or a second UE, a secret key (SK)/artificial noise (AN) (SK/AN) buffer status report (BSR) that includes information associated with one or more of an SK or an AN; transmit, to the network node or the second UE and based at least in part on the SK/AN BSR, a data BSR that indicates data that is available for transmission; and transmit, to the network node or the second UE, the data that is available based at least in part on the data BSR, wherein the data is secured based at least in part on one or more of the SK or the AN indicated by the SK/AN BSR. Additionally, or alternatively, the communication manager 140 may perform one or more other operations described herein.

In some aspects, a network node (e.g., network node 110) may include a communication manager 150. As described in more detail elsewhere herein, the communication manager 150 may receive, from a UE, an SK/AN BSR that includes information associated with one or more of an SK or an AN; receive, from the UE and based at least in part on the SK/AN BSR, a data BSR that indicates data that is available for transmission; and receive, from the UE, the data that is available based at least in part on the data BSR, wherein the data is secured based at least in part on one or more of the SK or the AN indicated by the SK/AN BSR. Additionally, or alternatively, the communication manager 150 may perform one or more other operations described herein.

As indicated above, FIG. 1 is provided as an example. Other examples may differ from what is described with regard to FIG. 1.

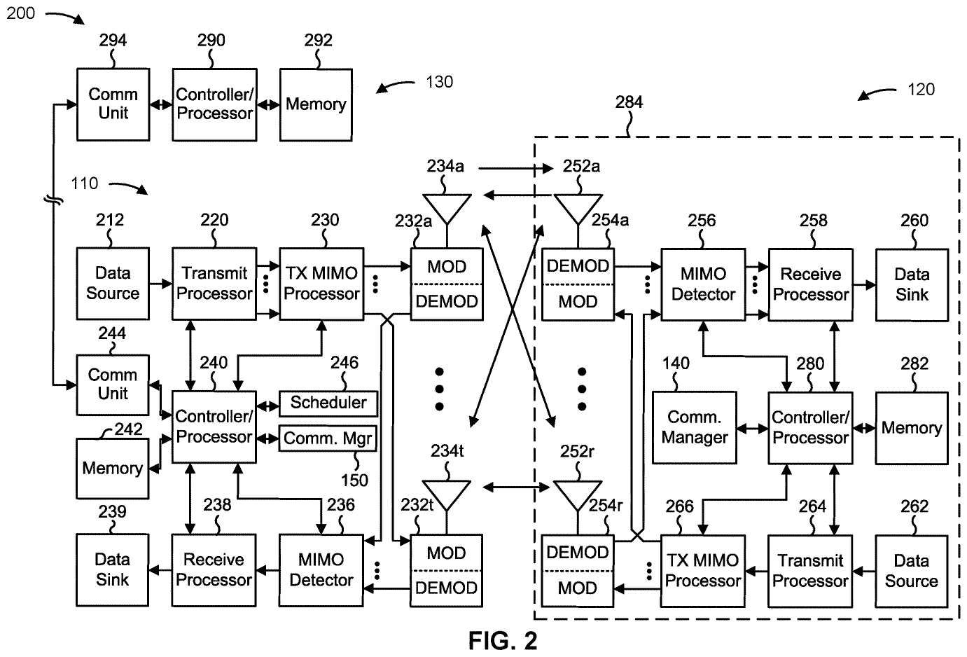

FIG. 2 is a diagram illustrating an example 200 of a network node 110 in communication with a UE 120 in a wireless network 100, in accordance with the present disclosure. The network node 110 may be equipped with a set of antennas 234 a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252 a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

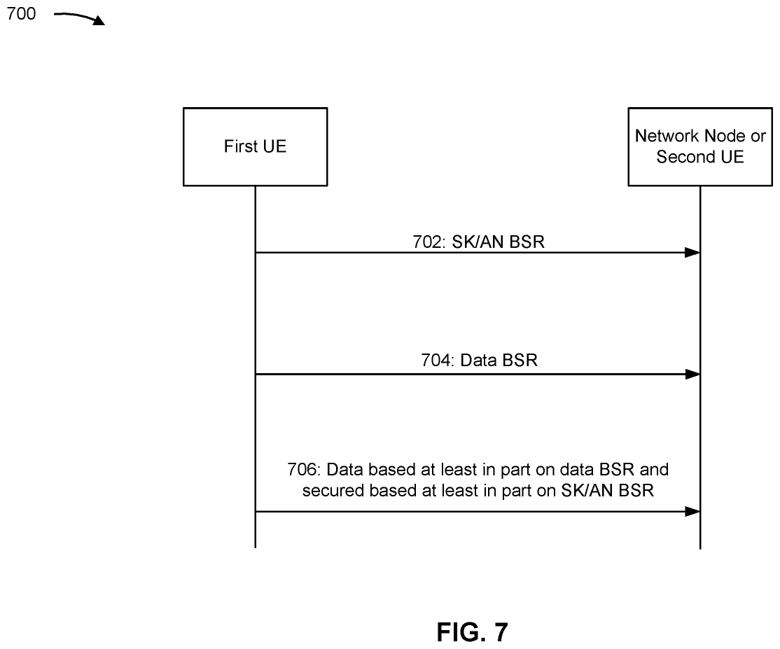

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-14).

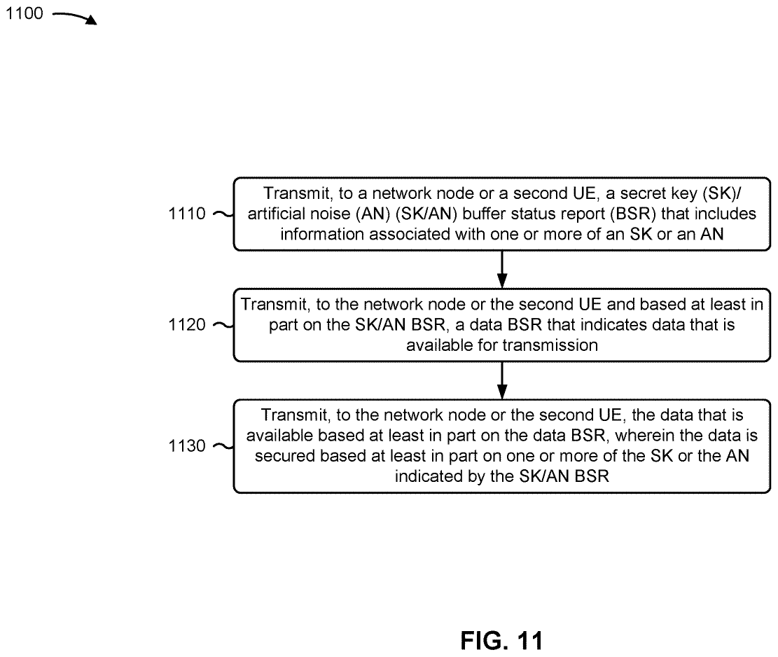

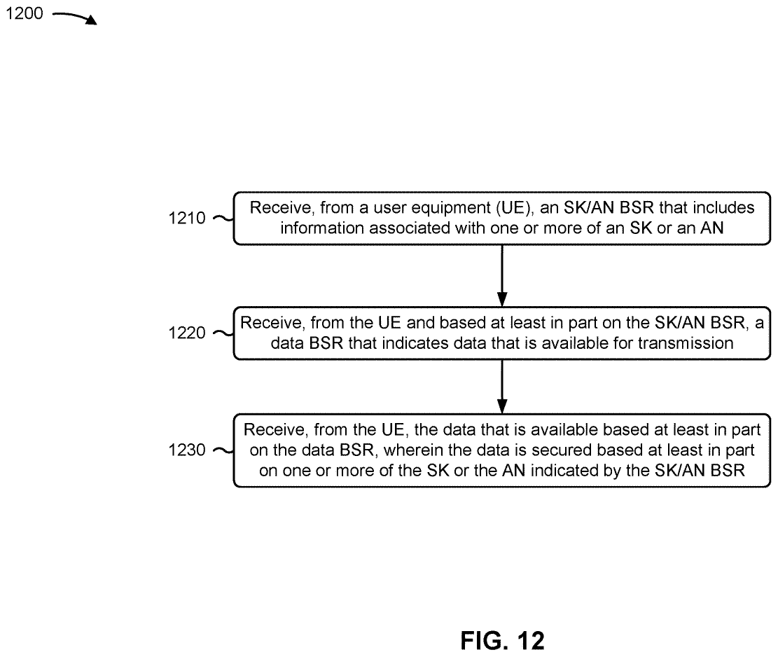

The controller/processor 240 of the network node 110, the controller/processor 280 of the UE 120, and/or any other component(s) of FIG. 2 may perform one or more techniques associated with transmitting SK/AN BSRs, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a first UE (e.g., UE 120a) includes means for transmitting, to a network node or a second UE, an SK/AN BSR that includes information associated with one or more of an SK or an AN; means for transmitting, to the network node or the second UE and based at least in part on the SK/AN BSR, a data BSR that indicates data that is available for transmission; and/or means for transmitting, to the network node or the second UE, the data that is available based at least in part on the data BSR, wherein the data is secured based at least in part on one or more of the SK or the AN indicated by the SK/AN BSR. In some aspects, the means for the apparatus to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for receiving, from a UE, an SK/AN BSR that includes information associated with one or more of an SK or an AN; means for receiving, from the UE and based at least in part on the SK/AN BSR, a data BSR that indicates data that is available for transmission; and/or means for receiving, from the UE, the data that is available based at least in part on the data BSR, wherein the data is secured based at least in part on one or more of the SK or the AN indicated by the SK/AN BSR. In some aspects, the means for the apparatus to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

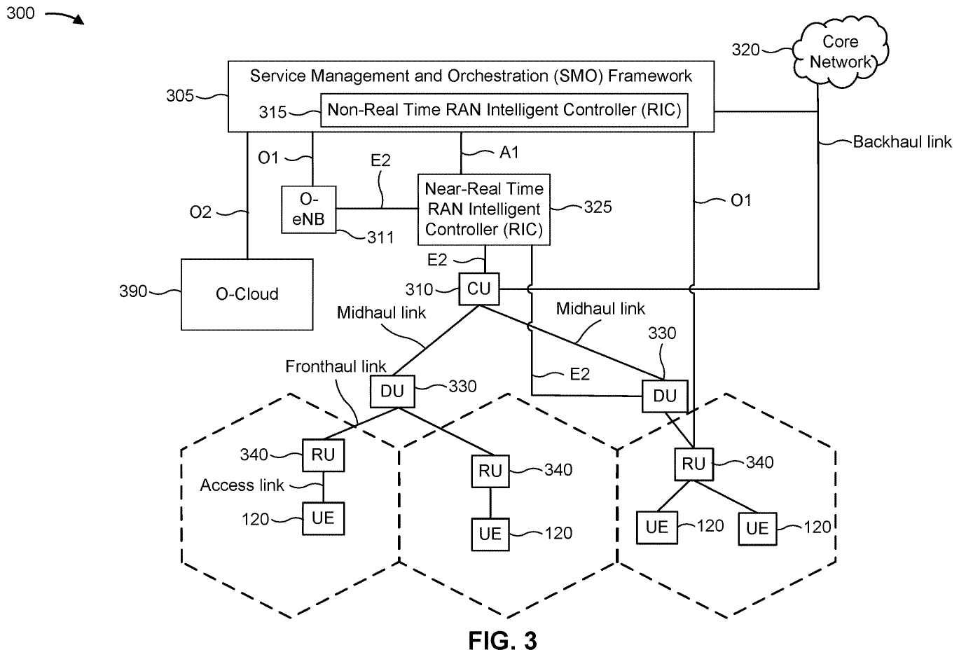

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

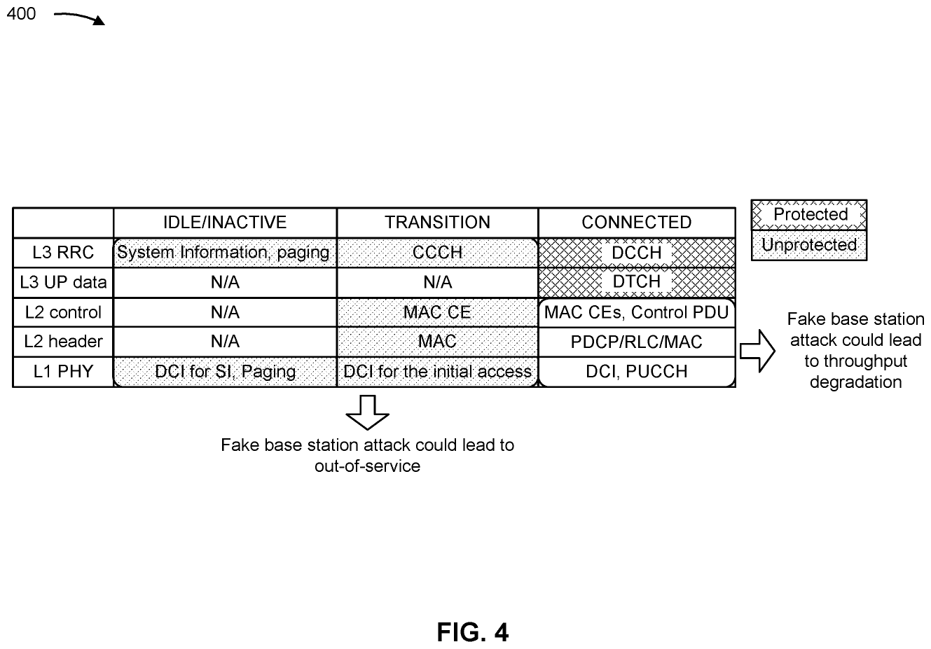

FIG. 4 is a diagram illustrating an example 400 of secure communications, in accordance with the present disclosure.

A UE may be in an idle/inactive state, a transition state, or a connected state. In the idle/inactive state, system information and paging via layer 3(L3 ) radio resource control (RRC) signaling may be unprotected (or not secure). In the idle/inactive state, downlink control information (DCI) for system information (SI) and paging via layer 1(L1 ) physical (PHY) signaling may be unprotected. In the transition state, a common control channel (CCCH) via the L3 RRC signaling may be unprotected. In the transition state, a medium access control control element (MAC-CE) via layer 2(L2 ) control signaling may be unprotected. In the transition state, a medium access control (MAC) layer associated with an L2 header may be unprotected. In the transition state, DCI for an initial access via LI PHY signaling may be unprotected. In the connected state, a dedicated control channel (DCCH) via L3 RRC signaling may be protected (or secure). In the connected state, a dedicated traffic channel (DTCH) via L3 user plane data signaling may be protected. In the connected state, MAC-CEs and control protocol data units (PDUs) via L2 control signaling may be unprotected. In the connected state, a packet data convergence protocol (PDCP) layer, a radio link control (RLC) layer, and/or a MAC layer associated with an L2 header may be unprotected. In the connected state, DCI and a physical uplink control channel (PUCCH) via L1 PHY signaling may be unprotected. As a result, due to many channels not being protected, attacks such as fake base station attacks may lead to out-of-service or throughput degradation for the UE.

As indicated above, FIG. 4 is provided as an example. Other examples may differ from what is described with regard to FIG. 4.

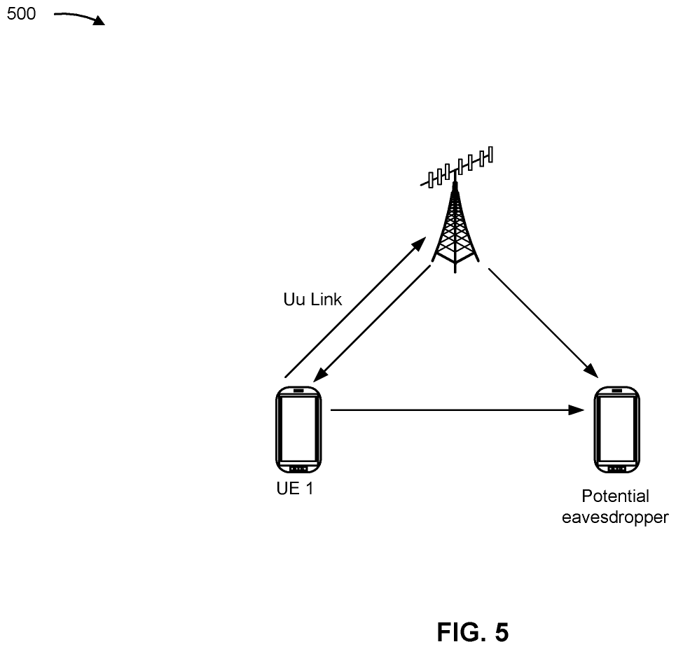

FIG. 5 is a diagram illustrating an example 500 of a potential eavesdropper UE, in accordance with the present disclosure.

As shown in FIG. 5, a first UE (UE 1) may communicate with a network node (e.g., a base station) via a Uu link. A second UE (e.g., a potential eavesdropper UE) may be in proximity to the first UE, and the second UE may detect communications between the first UE and the network node. For example, the network node may transmit data to the first UE, and the second UE may be considered to be a potential eavesdropper. The second UE may attempt to decode the data transmitted by the network node to the first UE.

As indicated above, FIG. 5 is provided as an example. Other examples may differ from what is described with regard to FIG. 5.

Security may be vital to wireless communication systems, and especially for IoT, since a large quantity of IoT devices may be connected to each other. Given the low level of power of IoT devices, additional secure bits obtained from channels and sounding signals between legitimate nodes may be added to increase security. Secret keys (SKs), which may be generated from a PHY layer or from upper layers for use in the PHY layer, may be used to generate artificial noise (AN) or jamming to illegitimate devices. Security keys may be used to rotate data. Security keys may be combined with data (e.g., based at least in part on an XOR operation) to achieve some level of security in the PHY layer. SKs may be used to secure unsecured channels that carry DCI or uplink control information (UCI), as well as other groupcast or broadcast channels associated with a Uu link or a sidelink interface.

An SK may be used for an AN injection. AN injection may be used to improve a PHY layer security by securing a data transmission. AN may be injected in a manner in which the AN is able to be canceled or removed at a legitimate receiver. In a first step, an SK may be shared between legitimate nodes. The SK may be based at least in part on upper layer techniques using Diffie-Hellman. The SK may be based at least in part on other symmetric key techniques, which may rely on elliptic curve cryptography (ECC). The SK may be available from a PHY layer using channel reciprocity and randomness. In a second step, AN may be generated based at least in part on the SK. A pseudo-random number generator with the SK as the seed may be used for generating the AN. The pseudo-random number generator may generate random signals, such as quadrature amplitude modulation (QAM), Gaussian, and/or uniform signals. In a third step, a receiver may cancel the AN prior to a data decoding, where the AN may function to secure the data that is transmitted.

An SK may be used to rotate or remap QAM points prior to a data transmission. A QAM rotation or remapping of constellation points may be used based at least in part on the SK. The same key or rotation may be used for M resource elements (REs), or may change with every RE. The rotation may be removed or canceled at a legitimate receiver prior to a data decoding because the legitimate receiver may have the SK.

An SK extraction may be based at least in part on channel randomness. In a first step, two devices, such as a network node and a UE, may transmit reference signals to each other. In a second step, the network node and the UE may each estimate a channel between the network node and the UE, which may be based at least in part on the reference signals. In a third step, the network node and the UE may obtain certain metrics based at least in part on the channel.

The metrics may include a channel power, an RSRP, a signal-to-interference-plus-noise ratio (SINR), and/or phase. In a fourth step, the network node and the UE may quantize a mapped value or use the mapped value as an input to a key derivation function. The network node and the UE may each obtain an SK, which may be obtained based at least in part on the key derivation function. The SK may be obtained based at least in part on the channel randomness associated with the channel between the network node and the UE. In high signal-to-noise (SNR) cases, the SK may be sufficient. Otherwise, the network node and the UE may perform a repetition of pilot signals and/or a key refinement procedure. In a sixth step, the network node and the UE may use the SK to secure transmissions to each other. The network node and the UE may use the SK to secure fields within a PHY channel. For example, the network node and/or the UE may use SKs to secure information transmitted in a physical downlink control channel (PDCCH), a PUCCH, a physical downlink shared channel (PDSCH), and/or a physical uplink shared channel (PUSCH).

A BSR may involve a MAC layer procedure, in which a UE may provide, to a network node, information regarding an amount of data available for transmission in an uplink buffer of the UE. The information regarding the amount of data may correspond to a size of data. The BSR may be a MAC layer message from the UE to the network node, which may indicate the data that the UE needs to transmit, and the network node may grant an uplink resource for transmitting the data based at least in part on the BSR.

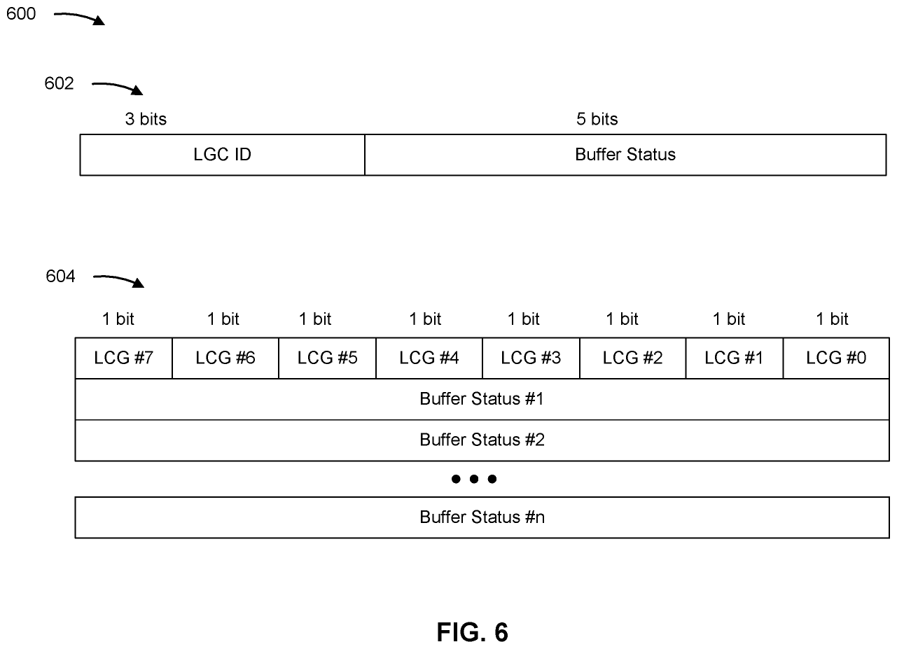

FIG. 6 is a diagram illustrating an example 600 of BSRs, in accordance with the present disclosure.

As shown by reference number 602, a short BSR (or a short truncated BSR) may include 8 bits, where 3 bits may be used to indicate a logical channel group (LCG) identifier (ID) field, and 5 bits may be used to indicate a corresponding BSR. The short BSR may provide information when only a single LCG has data to transfer. As shown by reference number 604, a long BSR (or a long truncated BSR) may be MAC-CEs having the same format but with variable sizes. A first byte may correspond to an LCG ID. A subsequent byte may indicate a BSR corresponding to the LCG ID. In other words, each LCG ID may be associated with its own BSR. The long BSR may use 8 bits, which may allow 256 indexes, which may accommodate a larger buffer status (e.g., 81,338,368 bytes). The long BSR may include up to n BSRs, where each BSR may correspond to a particular LCG ID. In this case, more than one LCG may have data to transfer.

As indicated above, FIG. 6 is provided as an example. Other examples may differ from what is described with regard to FIG. 6.

PHY layer security may be important for lower tier devices and for securing unsecured PHY channels, such as a physical sidelink feedback channel (PSFCH) and/or channels associated with DCI signaling, UCI signaling, or sidelink control information (SCI) signaling, as well as for providing an additional layer of security. However, PHY layer security may not implement AN and SKs in the context of BSRs, which may leave some devices more vulnerable to security attacks.

In various aspects of techniques and apparatuses described herein, a first UE may transmit, to a network node or a second UE, an SK/AN BSR that includes information associated with an SK and/or an AN. The first UE may transmit, to the network node or the second UE and based at least in part on the SK/AN BSR, a data BSR that indicates data that is available for transmission. The data may be uplink data to be transmitted to the network node, or the data may be sidelink data to be transmitted to the second UE. The first UE may transmit, to the network node or the second UE, the data that is available based at least in part on the data BSR. The first UE may secure the data based at least in part on the SK and/or the AN indicated by the SK/AN BSR. By securing the data using the SK and/or the AN, an overall system performance and reliability may be improved because the data may be more reliably transmitted from the first UE to the network node or the second UE.

In some aspects, “SK/AN BSR” may refer to an SK BSR and/or an AN BSR. In other words, the SK/AN BSR may be a combined BSR that indicates both the SK BSR and the AN BSR. Alternatively, the SK/AN BSR may indicate only one of the SK BSR or the AN BSR. The SK/AN BSR may be formed using a MAC-CE.

In some aspects, SKs and/or AN may be implemented in PHY layer security, where an injection of the AN may increase a maximum rate without leakage at eavesdroppers as compared to no injection of AN. The PHY layer security may be applicable to PHY layer channels between the first UE and the network node, and/or to PHY layer channels between the first UE and the second UE (e.g., sidelink channels). The first UE may indicate, to the network node or the second UE, and as part of a BSR or in a new MAC-CE, information associated with the SK/AN BSR. For example, the first UE may indicate an amount of AN symbols (and their representing bits). The first UE may indicate an SK, which may be based at least in part on an SK extraction technique including a PHY layer based SK extraction technique. Depending on whether an SK/AN BSR of a certain LCG has SKs/AN, the first UE may transmit data to the network node or the second UE. A scheduling of a data transmission may involve whether the LCG is associated with an SK and AN to secure transmissions. In other words, part of the scheduling may depend on whether the LCG is associated with the SK and/or the AN to secure data transmissions. Different LCGs may be associated with different SKs/AN, which may enable different security levels and different SKs/AN being associated with the different LCGs. When the SK/AN BSR is common among a plurality of LCGs (e.g., all LCGs), the first UE may attempt to utilize available bits for high priority data or high security data, as opposed to low priority data or low security data.

FIG. 7 is a diagram illustrating an example 700 associated with transmitting SK/AN BSRs, in accordance with the present disclosure. As shown in FIG. 7, example 700 includes communication between a first UE (e.g., UE 120a) and a network node (e.g., network node 110) or a second UE (e.g., UE 120e). In some aspects, the first UE and the network node or the second UE may be included in a wireless network, such as wireless network 100.

In some aspects, communications may be based at least in part on a Uu interface, which may be between the network node and a UE, such as the first UE or the second UE. Communications may be based at least in part on a PC5 or sidelink interface, which may be between the first UE and the second UE. Communications may be between network nodes (e.g., the network node to an IAB or relay node, or any device to any device).

As shown by reference number 702, the first UE may transmit, to the network node or the second UE, an SK/AN BSR that includes information associated with an SK and/or an AN. The SK/AN BSR may be associated with an LCG served by the first UE. The SK/AN BSR may indicate a size of the SK and/or the AN. The SK/AN BSR may be associated with a quantity of bits (e.g., 3 to 8 bits). In some cases, the SK/AN BSR may only include SK information. In some cases, the SK/AN BSR may only include AN information. In some cases, the SK/AN BSR may include both SK information and AN information.

As shown by reference number 704, the first UE may transmit, to the network node or the second UE and based at least in part on the SK/AN BSR, a data BSR that indicates data that is available for transmission. The data BSR may be associated with the LCG served by the first UE. The data BSR may indicate a size of the data that is available for transmission. The data BSR may be associated with a quantity of bits (e.g., 5 to 8 bits). The data may be uplink data to be transmitted from the first UE to the network node. The data may be sidelink data to be transmitted from the first UE to the second UE.

In some aspects, the size of the SK/AN BSR may be equal to or greater than the size of the data BSR. The first UE may transmit the data BSR based at least in part on the size of the SK/AN BSR being equal to or greater than the size of the data BSR, or based at least in part on a difference between the size of the SK/AN BSR and the size of the data BSR satisfying a threshold. In other words, when the size of the SK/AN BSR is equal to or greater than the size of the data BSR, or when the difference between the size of the SK/AN BSR and the size of the data BSR satisfies the threshold, the first UE may transmit the data BSR. In other cases, the first UE may not transmit the data BSR.

In some aspects, for the LCG to be served by the first UE, the first UE may transmit, to the network node or the second UE, the SK/AN BSR. The SK/AN BSR may be associated with the LCG. For example, the SK/AN BSR may be associated with an LCG ID of the LCG (a particular LCG ID). The size of the SK/AN BSR may be equal to or greater than the size of the data BSR, which may result in an ideal level of security. The SK/AN BSR and/or the data BSR may be associated with BSR MAC-CEs. The size of the SK/AN BSR may not be less than the size of the data BSR, which may otherwise result in an unideal level of security. The data BSR may be associated with the LCG. For example, the data BSR may be associated with the LCG ID of the LCG (the particular LCG ID). In some cases, a certain relationship may be configured between the SK/AN BSR and the data BSR. The relationship may define the size of the SK/AN BSR in relation to the size of the data BSR.

In some aspects, the first UE may transmit, to the network node or the second UE, the data BSR based at least in part on the size of the SK/AN BSR being equal to or greater than the size of the data BSR. In other words, a data BSR trigger may be based at least in part on a condition that the size of the SK/AN BSR is equal to or greater than the size of the data BSR. When the size of the SK/AN BSR is equal to or greater than the size of the data BSR, the first UE may transmit the data BSR. When the size of the SK/AN BSR is less than the size of the data BSR, the first UE may wait to transmit the data BSR. In some aspects, the first UE may transmit the data BSR to the network node or the second UE based at least in part on a difference between the size of the SK/AN BSR and the size of the data BSR satisfying a threshold. A value of the difference may be indicated to the first UE via layer 1 (L1), layer 2 (L2), or layer 3(L3 ) signaling, or the first UE may be preconfigured with the value (e.g., the value may be defined in a 3GPP Technical Specification (TS)).

In some aspects, a triggering to use a scheduling request associated with the data BSR may be based at least in part on the condition that the size of the SK/AN BSR is equal to or greater than the size of the data BSR. The first UE may transmit the scheduling request based at least in part on the size of the SK/AN BSR being equal to or greater than the size of the data BSR.

In some aspects, a size of the SK/AN BSR may be less than the size of the data BSR. In this case, the first UE may secure a portion of the data based at least in part on the size of the SK/AN BSR. The UE may extend the size of the SK/AN BSR using a pseudo-random number generator, such that the size of the SK/AN BSR becomes equal to or greater than the size of the data BSR. The UE may wait until an additional SK is derived. The UE may transmit a portion of the data, where the portion of the data may be associated with a quantity of bits that corresponds to the size of the SK/AN BSR, and a remaining portion of the data may not be transmitted.

In some aspects, AN symbols, which may be stored as bits and then converted to symbols, may be additive or multiplicative (e.g., multiplied to a signal similar to how a phase ramp or amplitude and phase multiplies, or a complex number (real and imaginary or amplitude and phase) multiplies, with data symbols/signals). The AN symbols may be associated with a type, such as Gaussian, quadrature amplitude modulation (QAM), phase shift keying (PSK), or Bernoulli. SK bits may be combined (e.g., via an XOR operation) with data, or may be used to encode or encrypt data.

In some aspects, when a size associated with AN information (e.g., a quantity of bits which are then mapped to symbols) is less than the size of the data BSR (after mapping), and/or when a size associated with SK information (which may be subjected to an XOR operation or used to encode/encrypt data) is less than the size of the data BSR, the first UE may perform one of several actions. In other words, when the size of the SK/AN BSR is less than the size of the data BSR, the first UE may perform one of several actions. The first UE may secure a portion of symbols/signals (with AN symbols/signals) or bits (with an SK). In other words, the first UE may only secure some of the data associated with the data BSR. A remaining portion of the data may be not secured. In this case, the first UE may transmit some secured data and some unsecured data. The first UE may extend AN bits and/or SK bits using a secure pseudo-random number generator or a key derivation function (e.g., a hash-based message authentication code secure hash algorithm (HMAC-SHA) or others) to correspond to the size of the data BSR, such that all of the data associated with the data BSR is secured. The first UE may wait until additional SKs and/or AN are obtained.

In some aspects, when the size of the SK/AN BSR is less than the size of the data BSR, the first UE may transmit data bits with a number of bits only associated with the size of the SK/AN BSR that is available. The first UE may transmit the scheduling request or the data BSR based at least in part on the threshold being satisfied. The first UE may transmit the data associated with the data BSR, where a size of the data may be associated with the size of the SK/AN BSR.

As an example, 100 bits of data may be available for transmission. An SK/AN may be associated with 90 bits. The first UE may transmit a scheduling request or the data BSR based at least in part on a threshold of 10. In this case, the first UE may only transmit 90 bits of the 100 bits, since only 90 bits are associated with the SK/AN. When the threshold is 20, the first UE may not transmit either the scheduling request or the data BSR.

In some aspects, the SK/AN BSR that includes the information associated with the SK and/or the AN may indicate a seed SK obtained from a physical layer security based SK extraction. The SK/AN BSR that includes the information associated with the SK and/or the AN may indicate SK bits buffered after a key derivation function is used. In other words, the SK/AN BSR may indicate the seed SK obtained from a PHY layer security based SK extraction scheme or another type of SK extraction scheme, or the SK/AN BSR may indicate the SK bits buffered after the key derivation function is used.

In some aspects, the first UE and/or the network node may flush or refresh a buffer that stores the information associated with the SK and/or the AN (e.g., SK/AN information). The first UE and/or the network node may flush or refresh the buffer based at least in part on an expiry of a timer. For example, the timer may expire when the first UE and/or the network node do not use the SK/AN information for a certain period of time. When the first UE and/or the network node flush or refresh the buffer, the first UE and/or the network node may transmit an indication of the buffer flushing or refreshing to other devices. For example, when the first UE flushes or refreshes the buffer, the first UE may transmit, to the network node and/or the second UE, an indication that the information associated with the SK and/or the AN has been flushed.

In some aspects, an LCG may be composed of multiple logical channels (LCHs), and each LCH may have a logical channel identifier (LCID or LCH ID), and each LCG may have an LCGID. Certain LCHs within an LCG may be high priority LCHs, and may be enabled or disabled to use a BSR (of an SK) associated with that LCG. For an AN and/or SK BSR, a plurality of LCHs (e.g., all LCHs) within an LCG may use the AN and/or SK BSR, or certain/specific LCHs within the LCG may use the AN and/or SK BSR. Regarding which LCHs within the LCG may use the SK, the LCH may be the highest priority LCH. The LCH may be K highest priority LCHs, where K is L1, L2, or L3 configured. A bitmap or signaling of which LCHs within the LCH may be used (e.g., a signal containing an LCH ID and which LCHs within a particular LCH may be used). Regardless of priorities, the bitmap or signaling may be L1, L2, or L3 configured/signaled. In some aspects, an indication of which mechanism should be used for selecting LCHs within an LCH (e.g., highest priority LCH, K highest priority LCHs, or bitmap or signaling) may be an L1, L2, or L3 enabled feature.

In some aspects, a long BSR of an LCG may be replaced by a first short BSR and a second short BSR, where the first short BSR may be associated with the SK/AN BSR and the second short BSR may be associated with the data BSR. For example, the long BSR may be 8 bits, and may be replaced by the first short BSR that includes 4 bits and the second short BSR that includes 4 bits. In other words, instead of having all 8 bits for the data BSR, the 8 bits may be split to indicate both the SK/AN BSR and the data BSR.

In some aspects, the first UE may have SK/AN information for each LCG. In this case, data of an LCG may be secured with an SK/AN BSR. The first UE may replace a long format report of a BSR for selected LCG IDs with a short format, such that some bits may be used for SK/AN BSR reporting, or a new format may be used. For example, four bits may be used for each BSR (e.g., a data BSR and an SK/AN BSR). In some aspects, new BSR tables may be defined based at least in part on each comb of number of bits for each BSR, or existing BSR tables may be modified by down selecting elements/entries, or the network node (or controller) may control a BSR configuration from time to time (e.g., via L1/L2/L3 signaling).

In some aspects, the SK/AN BSR may be added to the data BSR based at least in part on the SK/AN BSR being associated with a plurality of LCGs served by the first UE. The SK/AN BSR may be added to the data BSR using one or more LCGs, of the plurality of LCGs, that are not used for the data BSR. The one or more LCGs may be lower priority LCGs (as compared to other LCGs), or the one or more LCGs may be indicated by the network node as being able to be multiplexed with the SK/AN BSR.

In some aspects, when an SK/AN BSR is used for securing data from any LCG (e.g., the same SK/AN BSR is applicable to any one of the LCGs associated with a BSR), the first UE may piggyback SK/AN BSR information (e.g., SK/AN bits) with the data BSR. The first UE may use a data BSR of one or more LCGs to piggyback the SK/AN BSR. For example, the first UE may use a data BSR of lowest priority LCGs (e.g., if a certain upper layer parameter is configured) to piggyback the SK/AN BSR. Alternatively, the LCGs to be used by the first UE to piggyback the SK/AN BSR may be indicated by the network node. The network node may indicate which LCG BSR fields are shortened and are able to be multiplexed with SK/AN BSR information.

In some aspects, the LCG associated with the SK/AN BSR and the data BSR may be configured with an SK/AN PHY layer security. The LCG may be configured with the SK/AN PHY layer security based at least in part on a priority associated with the data, and when the LCG is configured with the SK/AN PHY layer security, a size associated with the SK/AN BSR may be predefined or may be indicated to the first UE by the network node. In some aspects, the first UE may receive, from the network node, an indication that activates or deactivates a security feature associated with securing the data using the SK/AN PHY layer security. When the first UE receives an indication that indicates an activation, the first UE may secure data using the SK/AN PHY layer security. When the first UE receives an indication that indicates a deactivation, the first UE may not secure data using the SK/AN PHY layer security.

In some aspects, all LCGs (or groups of LCGs) may not necessarily have an SK/AN BSR or will be secured with SK/AN PHY layer security. The network node may separately configure each LCG to have or not have an SK/AN BSR. The network node may secure particular data with SK/AN PHY layer security based at least in part on a priority associated with the data. When data transmitted by the first UE is secured using SK/AN PHY layer security, the size of the SK/AN BSR associated with the data may be indicated by the network node to the first UE or predefined at the first UE. In some aspects, when configuring the LCG, per an LCG ID associated with the LCG, the network node may activate or deactivate the security feature associated with the SK/AN PHY layer security.

In some aspects, a security level may be defined for an LCG associated with the SK/AN BSR and the data BSR. The security level may be based at least in part on the SK and/or the AN that is obtained using a physical layer technique or an upper layer technique. In some aspects, a scheduling of an LCG associated with the SK/AN BSR and the data BSR may be based at least in part on an availability of the SK and/or the AN.

In some aspects, when configuring the LCG, per the LCG ID, the network node may define the security level. The security level may be associated with a certain mechanism for obtaining the SK, or may indicate the relation between an amount of SKs/AN to use with a data transmission from a corresponding uplink buffer or for the LCG. In some aspects, the security level may be defined for each LCG. The security level may be based at least in part on a strength of an SK/AN obtained using PHY layer or upper layer techniques. In some aspects, scheduling for the LCG may be based at least in part on an availability of SKs. A minimum available SK size for use relative to a data size may be defined.

In some aspects, a scheduling request occasion may be useable based at least in part on the availability of the SK and/or the AN, or based at least in part on an ability to obtain the SK and/or the AN to trigger the SK/AN BSR. The scheduling request occasion may be useable based at least in part on an availability of high priority data, as opposed to low priority data.

In some aspects, new scheduling request occasions may be defined, and may be associated with a condition of the availability of the SK/AN, or a condition of an ability to obtain new SKs (e.g., timer based or configuration) to trigger the SK/AN BSR. In other words, the new scheduling request occasions may only be used when the SK/AN is available, or when new SKs may be obtained to trigger the SK/AN BSR. The new scheduling request occasions may be used based at least in part on the availability of high priority data. The availability of the high priority data may be a trigger for a piggyback condition, which may occur when both data arrives and an SK/AN based condition occurs. The new scheduling request occasions may be used for triggering the SK/AN BSR and/or the data. In some aspects, a new SK/AN BSR (or a new SK BSR and a new AN BSR) may be defined. The new SK/AN BSR may have different levels than a legacy data BSR (e.g., the data BSR), or the new SK/AN BSR may have the same levels as the legacy data BSR.

As shown by reference number 706, the first UE may transmit, to the network node or the second UE, the data that is available based at least in part on the data BSR. In other words, the first UE may transmit the data with the size indicated in the data BSR. The first UE may secure the data based at least in part on the SK and/or the AN indicated by the SK/AN BSR. In other words, the first UE may secure the data using the information associated with the SK and/or the AN, as indicated by the SK/AN BSR. The first UE may use the SK and/or the AN to achieve the SK/AN PHY layer security. In some aspects, the first UE may secure uplink data that is transmitted to the network node. In some aspects, the first UE may secure sidelink data that is transmitted to the second UE.

As indicated above, FIG. 7 is provided as an example. Other examples may differ from what is described with regard to FIG. 7.

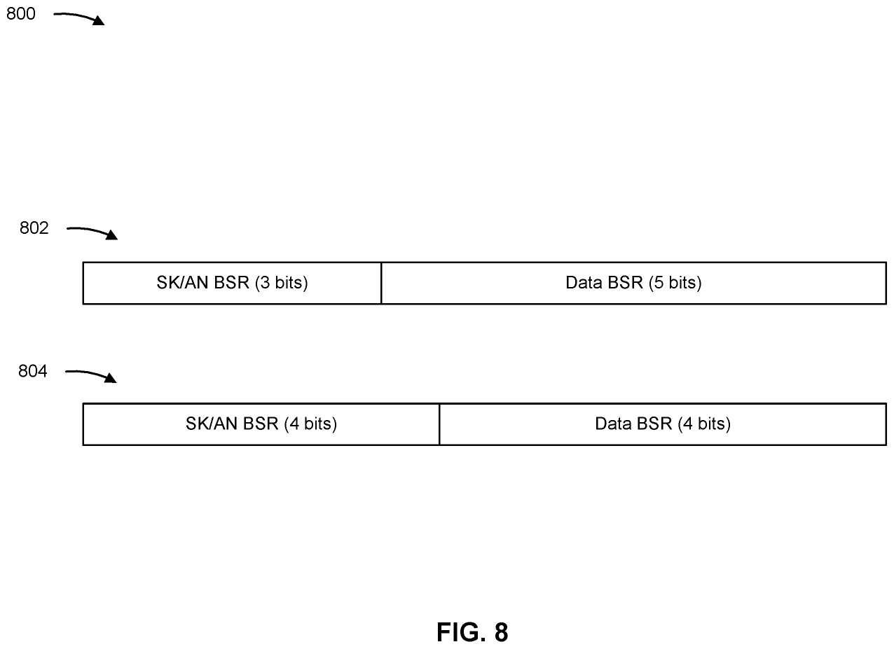

FIG. 8 is a diagram illustrating an example 800 associated with transmitting SK/AN BSRs, in accordance with the present disclosure.

As shown by reference number 802, three bits may be used for an SK/AN BSR and five bits may be used for a data BSR. The SK/AN BSR may be associated with a particular LCG. Data of the LCG may be used with the SK/AN BSR. As shown by reference number 804, four bits may be used for an SK/AN BSR and four bits may be used for a data BSR.

As indicated above, FIG. 8 is provided as an example. Other examples may differ from what is described with regard to FIG. 8.

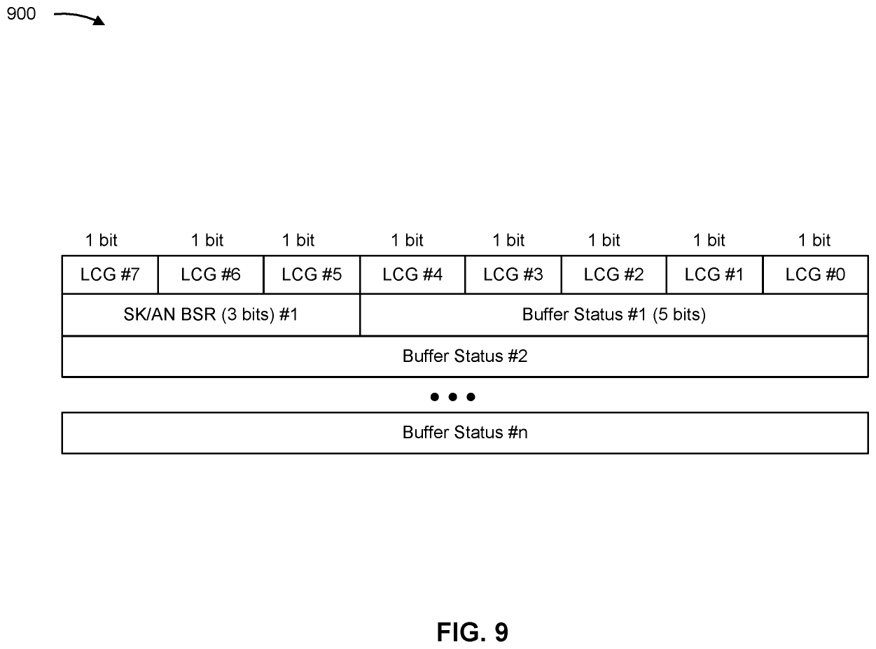

FIG. 9 is a diagram illustrating an example 900 associated with transmitting SK/AN BSRs, in accordance with the present disclosure.

As shown in FIG. 9, a long BSR of a certain LCG ID (e.g., LCG ID #0) may be replaced with a short BSR. Three bits may be used for an SK/AN BSR and five bits may be used for a buffer status, which may be associated with a data BSR. The SK/AN BSR and the data BSR may both be associated with the same LCG. Other LCGs may not be associated with SK/AN BSRs (e.g., LCG ID #2).

As indicated above, FIG. 9 is provided as an example. Other examples may differ from what is described with regard to FIG. 9.

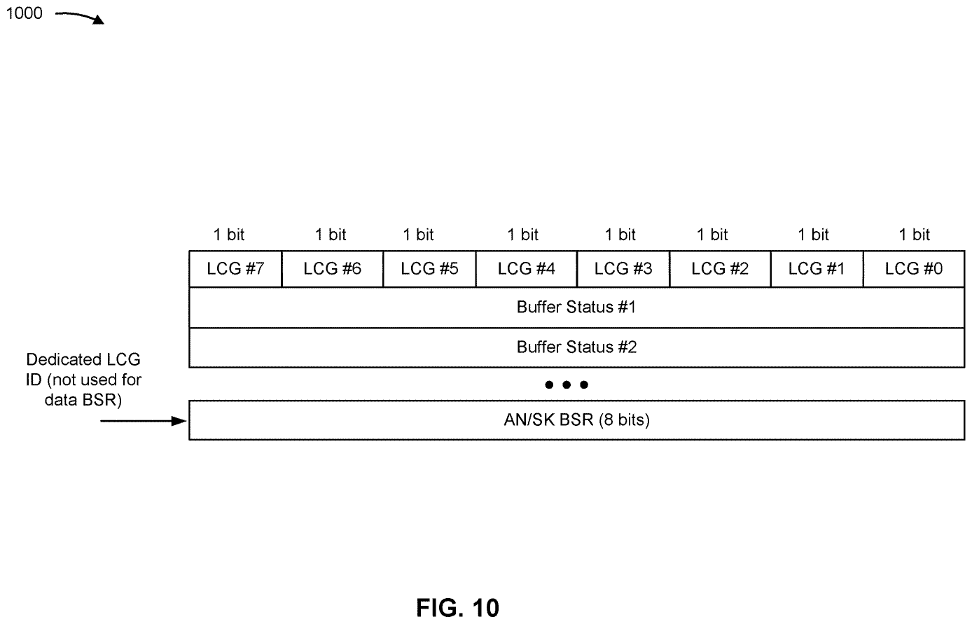

FIG. 10 is a diagram illustrating an example 1000 associated with transmitting SK/AN BSRs, in accordance with the present disclosure.

As shown in FIG. 10, a new dedicated LCG ID may be used as a new logical channel identifier (LCID) for an SK/AN BSR, especially when the SK/AN BSR is to be used for a plurality of LCGs (e.g., all LCGs associated with a BSR). For example, a dedicated LCG ID, which is not used for a data BSR, may be associated with an SK/AN BSR. The SK/AN BSR may be formed using 8 bits.

As indicated above, FIG. 10 is provided as an example. Other examples may differ from what is described with regard to FIG. 10.

FIG. 11 is a diagram illustrating an example process 1100 performed, for example, by a first UE, in accordance with the present disclosure. Example process 1100 is an example where the first UE (e.g., UE 120a) performs operations associated with transmitting SK/AN BSRs.

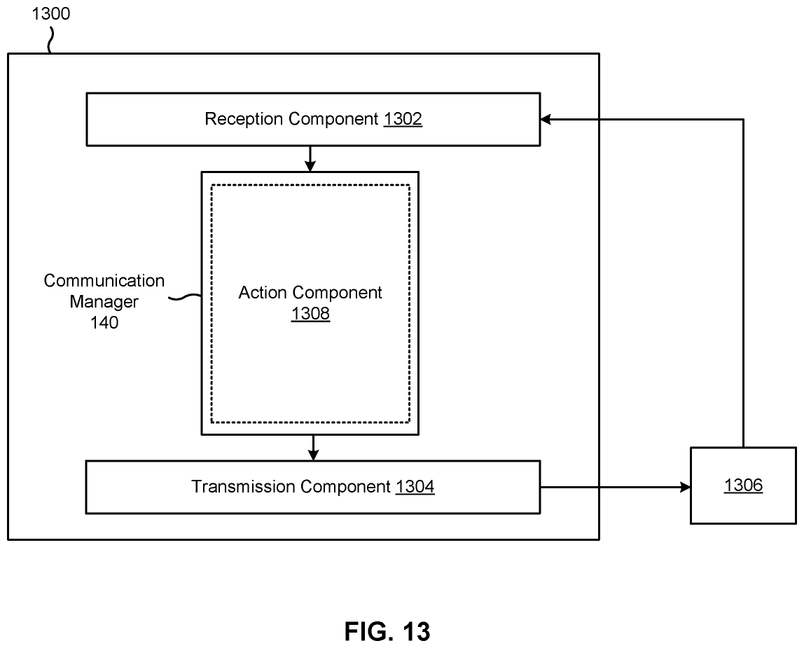

As shown in FIG. 11, in some aspects, process 1100 may include transmitting, to a network node or a second UE, an SK/AN BSR that includes information associated with one or more of an SK or an AN (block 1110). For example, the first UE (e.g., using communication manager 140 and/or transmission component 1304, depicted in FIG. 13) may transmit, to a network node or a second UE, an SK/AN BSR that includes information associated with one or more of an SK or an AN, as described above.

As further shown in FIG. 11, in some aspects, process 1100 may include transmitting, to the network node or the second UE and based at least in part on the SK/AN BSR, a data BSR that indicates data that is available for transmission (block 1120). For example, the first UE (e.g., using communication manager 140 and/or transmission component 1304, depicted in FIG. 13) may transmit, to the network node or the second UE and based at least in part on the SK/AN BSR, a data BSR that indicates data that is available for transmission, as described above.

As further shown in FIG. 11, in some aspects, process 1100 may include transmitting, to the network node or the second UE, the data that is available based at least in part on the data BSR, wherein the data is secured based at least in part on one or more of the SK or the AN indicated by the SK/AN BSR (block 1130). For example, the first UE (e.g., using communication manager 140 and/or transmission component 1304, depicted in FIG. 13) may transmit, to the network node or the second UE, the data that is available based at least in part on the data BSR, wherein the data is secured based at least in part on one or more of the SK or the AN indicated by the SK/AN BSR, as described above.

Process 1100 may include additional aspects, such as any single aspect or any combination of aspects described below and/or in connection with one or more other processes described elsewhere herein.

In a first aspect, the SK/AN BSR is associated with an LCG served by the first UE, and the data BSR is associated with the LCG.

In a second aspect, alone or in combination with the first aspect, a size of the SK/AN BSR is equal to or greater than a size of the data BSR.

In a third aspect, alone or in combination with one or more of the first and second aspects, the data BSR is transmitted based at least in part on a size of the SK/AN BSR being equal to or greater than a size of the data BSR, or based at least in part on a difference between the size of the SK/AN BSR and the size of the data BSR satisfying a threshold.

In a fourth aspect, alone or in combination with one or more of the first through third aspects, a size of the SK/AN BSR is less than a size of the data BSR, and process 1100 includes securing a portion of the data based at least in part on the size of the SK/AN BSR; extending the size of the SK/AN BSR using a pseudo-random number generator such that the size of the SK/AN BSR becomes equal to or greater than the size of the data BSR; waiting until an additional SK is derived; or transmitting a portion of the data, wherein the portion of the data is associated with a quantity of bits that corresponds to the size of the SK/AN BSR, and wherein a remaining portion of the data is not transmitted.

In a fifth aspect, alone or in combination with one or more of the first through fourth aspects, the SK/AN BSR that includes the information associated with one or more of the SK or the AN indicates a seed SK obtained from a PHY layer security based SK extraction, or buffering SK bits after using a key derivation function.

In a sixth aspect, alone or in combination with one or more of the first through fifth aspects, process 1100 includes flushing, based at least in part on an expiry of a timer, a buffer that stores the information associated with one or more of the SK or the AN, and transmitting, to the network node or the second UE, an indication that the information associated with one or more of the SK or the AN has been flushed.

In a seventh aspect, alone or in combination with one or more of the first through sixth aspects, a long BSR of an LCG is replaced by a first short BSR and a second short BSR, wherein the first short BSR is associated with the SK/AN BSR and the second short BSR is associated with the data BSR.

In an eighth aspect, alone or in combination with one or more of the first through seventh aspects, the SK/AN BSR is added to the data BSR based at least in part on the SK/AN BSR being associated with a plurality of LCGs served by the first UE, wherein the SK/AN BSR is added to the data BSR using one or more LCGs, of the plurality of LCGs, that are not used for the data BSR, wherein the one or more LCGs are lower priority LCGs, or wherein the one or more LCGs are indicated by the network node as being able to be multiplexed with the SK/AN BSR.

In a ninth aspect, alone or in combination with one or more of the first through eighth aspects, an LCG associated with the SK/AN BSR and the data BSR is configured with an SK/AN PHY layer security, wherein the LCG is configured with the SK/AN PHY layer security based at least in part on a priority associated with the data, and a size associated with the SK/AN BSR is predefined or is indicated to the first UE by the network node.

In a tenth aspect, alone or in combination with one or more of the first through ninth aspects, process 1100 includes receiving, from the network node, an indication that activates or deactivates a security feature associated with securing the data using an SK/AN PHY layer security.

In an eleventh aspect, alone or in combination with one or more of the first through tenth aspects, a security level is defined for an LCG associated with the SK/AN BSR and the data BSR, and the security level is based at least in part on one or more of the SK or the AN that is obtained using a PHY layer or upper layer technique.

In a twelfth aspect, alone or in combination with one or more of the first through eleventh aspects, a scheduling of an LCG associated with the SK/AN BSR and the data BSR is based at least in part on an availability of one or more of the SK or the AN.

In a thirteenth aspect, alone or in combination with one or more of the first through twelfth aspects, a scheduling request occasion is useable based at least in part on an availability of one or more of the SK or the AN, or based at least in part on an ability to obtain one or more of the SK or the AN to trigger the SK/AN BSR, and the scheduling request occasion is useable based at least in part on an availability of high priority data.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with transmitting SK/AN BSRs.

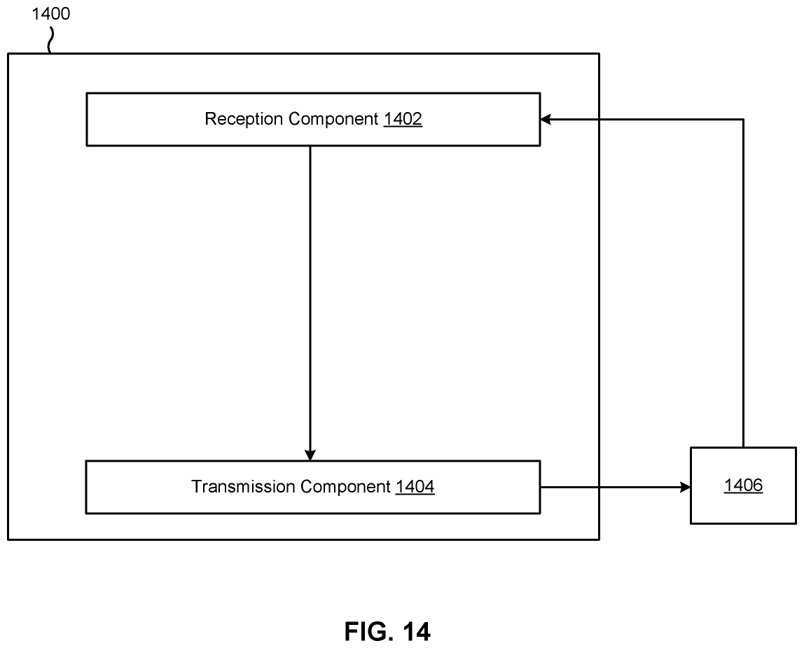

As shown in FIG. 12, in some aspects, process 1200 may include receiving, from a UE, an SK/AN BSR that includes information associated with one or more of an SK or an AN (block 1210). For example, the network node (e.g., using reception component 1402, depicted in FIG. 14) may receive, from a UE, an SK/AN BSR that includes information associated with one or more of an SK or an AN, as described above.

As further shown in FIG. 12, in some aspects, process 1200 may include receiving, from the UE and based at least in part on the SK/AN BSR, a data BSR that indicates data that is available for transmission (block 1220). For example, the network node (e.g., using reception component 1402, depicted in FIG. 14) may receive, from the UE and based at least in part on the SK/AN BSR, a data BSR that indicates data that is available for transmission, as described above.

As further shown in FIG. 12, in some aspects, process 1200 may include receiving, from the UE, the data that is available based at least in part on the data BSR, wherein the data is secured based at least in part on one or more of the SK or the AN indicated by the SK/AN BSR (block 1230). For example, the network node (e.g., using reception component 1402, depicted in FIG. 14) may receive, from the UE, the data that is available based at least in part on the data BSR, wherein the data is secured based at least in part on one or more of the SK or the AN indicated by the SK/AN BSR, as described above.

Process 1200 may include additional aspects, such as any single aspect or any combination of aspects described below and/or in connection with one or more other processes described elsewhere herein.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a first UE, or a first UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include an action component 1308, among other examples.

In some aspects, the apparatus 1300 may be configured to perform one or more operations described herein in connection with FIGS. 7-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The transmission component 1304 may transmit, to a network node or a second UE, an SK/AN BSR that includes information associated with one or more of an SK or an AN. The transmission component 1304 may transmit, to the network node or the second UE and based at least in part on the SK/AN BSR, a data BSR that indicates data that is available for transmission. The transmission component 1304 may transmit, to the network node or the second UE, the data that is available based at least in part on the data BSR, wherein the data is secured based at least in part on one or more of the SK or the AN indicated by the SK/AN BSR.

The transmission component 1304 may transmit the data BSR based at least in part on a size of the SK/AN BSR being equal to or greater than a size of the data BSR, or based at least in part on a difference between the size of the SK/AN BSR and the size of the data BSR satisfying a threshold.

The action component 1308 may, when a size of the SK/AN BSR is less than a size of the data BSR, secure a portion of the data based at least in part on the size of the SK/AN BSR. The action component 1308 may extend the size of the SK/AN BSR using a pseudo-random number generator such that the size of the SK/AN BSR becomes equal to or greater than the size of the data BSR. The action component 1308 may wait until an additional SK is derived. The transmission component 1304 may transmit a portion of the data, wherein the portion of the data is associated with a quantity of bits that corresponds to the size of the SK/AN BSR, and wherein a remaining portion of the data is not transmitted.

The action component 1308 may flush, based at least in part on an expiry of a timer, a buffer that stores the information associated with one or more of the SK or the AN. The transmission component 1304 may transmit, to the network node or the second UE, an indication that the information associated with one or more of the SK or the AN has been flushed. The reception component 1302 may receive, from the network node, an indication that activates or deactivates a security feature associated with securing the data using an SK/AN PHY layer security.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404.

In some aspects, the apparatus 1400 may be configured to perform one or more operations described herein in connection with FIGS. 7-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The reception component 1402 may receive, from a UE, an SK/AN BSR that includes information associated with one or more of an SK or an AN. The reception component 1402 may receive, from the UE and based at least in part on the SK/AN BSR, a data BSR that indicates data that is available for transmission. The reception component 1402 may receive, from the UE, the data that is available based at least in part on the data BSR, wherein the data is secured based at least in part on one or more of the SK or the AN indicated by the SK/AN BSR.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by an apparatus of a first user equipment (UE), comprising: transmitting, to a network node or a second UE, a secret key (SK)/artificial noise (AN) (SK/AN) buffer status report (BSR) that includes information associated with one or more of an SK or an AN; transmitting, to the network node or the second UE and based at least in part on the SK/AN BSR, a data BSR that indicates data that is available for transmission; and transmitting, to the network node or the second UE, the data that is available based at least in part on the data BSR, wherein the data is secured based at least in part on one or more of the SK or the AN indicated by the SK/AN BSR.

Aspect 2: The method of Aspect 1, wherein the SK/AN BSR is associated with a logical channel group (LCG) served by the first UE, and wherein the data BSR is associated with the LCG.

Aspect 3: The method of any of Aspects 1 through 2, wherein a size of the SK/AN BSR is equal to or greater than a size of the data BSR.

Aspect 4: The method of any of Aspects 1 through 3, wherein the data BSR is transmitted based at least in part on a size of the SK/AN BSR being equal to or greater than a size of the data BSR, or based at least in part on a difference between the size of the SK/AN BSR and the size of the data BSR satisfying a threshold.

Aspect 5: The method of any of Aspects 1 through 4, wherein a size of the SK/AN BSR is less than a size of the data BSR, and further comprising: securing a portion of the data based at least in part on the size of the SK/AN BSR; extending the size of the SK/AN BSR using a pseudo-random number generator such that the size of the SK/AN BSR becomes equal to or greater than the size of the data BSR; waiting until an additional SK is derived; or transmitting a portion of the data, wherein the portion of the data is associated with a quantity of bits that corresponds to the size of the SK/AN BSR, and wherein a remaining portion of the data is not transmitted.

Aspect 6: The method of any of Aspects 1 through 5, wherein the SK/AN BSR that includes the information associated with one or more of the SK or the AN indicates: a seed SK obtained from a physical layer security based SK extraction; or SK bits buffered after a key derivation function is used.

Aspect 7: The method of any of Aspects 1 through 6, further comprising: flushing, based at least in part on an expiry of a timer, a buffer that stores the information associated with one or more of the SK or the AN; and transmitting, to the network node or the second UE, an indication that the information associated with one or more of the SK or the AN has been flushed.

Aspect 8: The method of any of Aspects 1 through 7, wherein a long BSR of a logical channel group is replaced by a first short BSR and a second short BSR, wherein the first short BSR is associated with the SK/AN BSR and the second short BSR is associated with the data BSR.

Aspect 9: The method of any of Aspects 1 through 8, wherein the SK/AN BSR is added to the data BSR based at least in part on the SK/AN BSR being associated with a plurality of logical channel groups (LCGs) served by the first UE, wherein the SK/AN BSR is added to the data BSR using one or more LCGs, of the plurality of LCGs, that are not used for the data BSR, wherein the one or more LCGs are lower priority LCGs, or wherein the one or more LCGs are indicated by the network node as being able to be multiplexed with the SK/AN BSR.

Aspect 10: The method of any of Aspects 1 through 9, wherein a logical channel group (LCG) associated with the SK/AN BSR and the data BSR is configured with an SK/AN physical layer security, wherein the LCG is configured with the SK/AN physical layer security based at least in part on a priority associated with the data, and wherein a size associated with the SK/AN BSR is predefined or is indicated to the first UE by the network node.

Aspect 11: The method of any of Aspects 1 through 10, further comprising: receiving, from the network node, an indication that activates or deactivates a security feature associated with securing the data using an SK/AN physical layer security.

Aspect 12: The method of any of Aspects 1 through 11, wherein a security level is defined for a logical channel group associated with the SK/AN BSR and the data BSR, and wherein the security level is based at least in part on one or more of the SK or the AN that is obtained using a physical layer technique or an upper layer technique.

Aspect 13: The method of any of Aspects 1 through 12, wherein a scheduling of a logical channel group associated with the SK/AN BSR and the data BSR is based at least in part on an availability of one or more of the SK or the AN.

Aspect 14: The method of any of Aspects 1 through 13, wherein a scheduling request occasion is useable based at least in part on an availability of one or more of the SK or the AN or based at least in part on an ability to obtain one or more of the SK or the AN to trigger the SK/AN BSR, and wherein the scheduling request occasion is useable based at least in part on an availability of high priority data.

Aspect 15: A method of wireless communication performed by an apparatus of a network node, comprising: receiving, from a user equipment (UE), a secret key (SK)/artificial noise (AN) (SK/AN) buffer status report (BSR) that includes information associated with one or more of an SK or an AN; receiving, from the UE and based at least in part on the SK/AN BSR, a data BSR that indicates data that is available for transmission; and receiving, from the UE, the data that is available based at least in part on the data BSR, wherein the data is secured based at least in part on one or more of the SK or the AN indicated by the SK/AN BSR.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspect 15.

Aspect 22: A device for wireless communication, comprising a memory and one or more processors coupled to the memory, the one or more processors configured to perform the method of Aspect 15.

Aspect 23: An apparatus for wireless communication, comprising at least one means for performing the method of Aspect 15.

Aspect 24: A non-transitory computer-readable medium storing code for wireless communication, the code comprising instructions executable by a processor to perform the method of Aspect 15.

Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a first user equipment (UE), comprising:
a memory; and
one or more processors, coupled to the memory, configured to:
transmit, to a network node or a second UE, a secret key (SK)/artificial noise (AN) (SK/AN) buffer status report (BSR) that includes information associated with one or more of an SK or an AN;
transmit, to the network node or the second UE and based at least in part on the SK/AN BSR, a data BSR that indicates data that is available for transmission; and transmit, to the network node or the second UE, the data that is available based at least in part on the data BSR, wherein the data is secured based at least in part on one or more of the SK or the AN indicated by the SK/AN BSR.

2. The apparatus of claim 1, wherein the SK/AN BSR is associated with a logical channel group (LCG) served by the first UE, and wherein the data BSR is associated with the LCG.

3. The apparatus of claim 1, wherein a size of the SK/AN BSR is equal to or greater than a size of the data BSR.

4. The apparatus of claim 1, wherein the one or more processors are configured to transmit the data BSR based at least in part on a size of the SK/AN BSR being equal to or greater than a size of the data BSR, or based at least in part on a difference between the size of the SK/AN BSR and the size of the data BSR satisfying a threshold.

5. The apparatus of claim 1, wherein a size of the SK/AN BSR is less than a size of the data BSR, and wherein the one or more processors are configured to:
secure a portion of the data based at least in part on the size of the SK/AN BSR; extend the size of the SK/AN BSR using a pseudo-random number generator such that the size of the SK/AN BSR becomes equal to or greater than the size of the data BSR;
wait until an additional SK is derived; or
transmit a portion of the data, wherein the portion of the data is associated with a quantity of bits that corresponds to the size of the SK/AN BSR, and wherein a remaining portion of the data is not transmitted.

6. The apparatus of claim 1, wherein the SK/AN BSR that includes the information associated with one or more of the SK or the AN indicates:
a seed SK obtained from a physical layer security based SK extraction; or
SK bits buffered after a key derivation function is used.

7. The apparatus of claim 1, wherein the one or more processors are further configured to:
flush, based at least in part on an expiry of a timer, a buffer that stores the information associated with one or more of the SK or the AN; and
transmit, to the network node or the second UE, an indication that the information associated with one or more of the SK or the AN has been flushed.

8. The apparatus of claim 1, wherein a long B SR of a logical channel group is replaced by a first short BSR and a second short BSR, and wherein the first short BSR is associated with the SK/AN BSR and the second short BSR is associated with the data BSR.

9. The apparatus of claim 1, wherein the SK/AN BSR is added to the data BSR based at least in part on the SK/AN BSR being associated with a plurality of logical channel groups (LCGs) served by the first UE, wherein the SK/AN BSR is added to the data BSR using one or more LCGs, of the plurality of LCGs, that are not used for the data BSR, wherein the one or more LCGs are lower priority LCGs, or wherein the one or more LCGs are indicated by the network node as being able to be multiplexed with the SK/AN BSR.

10. The apparatus of claim 1, wherein a logical channel group (LCG) associated with the SK/AN BSR and the data BSR is configured with an SK/AN physical layer security, wherein the LCG is configured with the SK/AN physical layer security based at least in part on a priority associated with the data, and wherein a size associated with the SK/AN BSR is predefined or is indicated to the first UE by the network node.

11. The apparatus of claim 1, wherein the one or more processors are further configured to:
receive, from the network node, an indication that activates or deactivates a security feature associated with securing the data using an SK/AN physical layer security.

12. The apparatus of claim 1, wherein a security level is defined for a logical channel group associated with the SK/AN BSR and the data BSR, and wherein the security level is based at least in part on one or more of the SK or the AN that is obtained using a physical layer technique or an upper layer technique.

13. The apparatus of claim 1, wherein a scheduling of a logical channel group associated with the SK/AN BSR and the data BSR is based at least in part on an availability of one or more of the SK or the AN.

14. The apparatus of claim 1, wherein a scheduling request occasion is useable based at least in part on an availability of one or more of the SK or the AN or based at least in part on an ability to obtain one or more of the SK or the AN to trigger the SK/AN BSR, and wherein the scheduling request occasion is useable based at least in part on an availability of high priority data.

15. An apparatus for wireless communication at a network node, comprising:
a memory; and
one or more processors, coupled to the memory, configured to:
receive, from a user equipment (UE), a secret key (SK)/artificial noise (AN) (SK/AN) buffer status report (BSR) that includes information associated with one or more of an SK or an AN;
receive, from the UE and based at least in part on the SK/AN BSR, a data BSR that indicates data that is available for transmission; and
receive, from the UE, the data that is available based at least in part on the data BSR, wherein the data is secured based at least in part on one or more of the SK or the AN indicated by the SK/AN BSR.

16. A method of wireless communication performed by an apparatus of a first user equipment (UE), comprising:
transmitting, to a network node or a second UE, a secret key (SK)/artificial noise (AN) (SK/AN) buffer status report (BSR) that includes information associated with one or more of an SK or an AN;
transmitting, to the network node or the second UE and based at least in part on the SK/AN BSR, a data BSR that indicates data that is available for transmission; and transmitting, to the network node or the second UE, the data that is available based at least in part on the data BSR, wherein the data is secured based at least in part on one or more of the SK or the AN indicated by the SK/AN BSR.

17. The method of claim 16, wherein the SK/AN BSR is associated with a logical channel group (LCG) served by the first UE, and wherein the data BSR is associated with the LCG.

18. The method of claim 16, wherein a size of the SK/AN BSR is equal to or greater than a size of the data BSR.

19-25. (canceled)

26. The method of claim 16, further comprising:
receiving, from the network node, an indication that activates or deactivates a security feature associated with securing the data using an SK/AN physical layer security.

27-30. (canceled)
